(19) United States
(12) Patent Application Publication
(10) Pub. No.: US 2023/0399760 A1
(43) Pub. Date: Dec. 14, 2023

(54) ELECTROCHEMICAL CATALYSTS AND MANUFACTURING METHOD THEREOF

(71) Applicant: Industry-Academic Cooperation Foundation, YONSEI UNIVERSITY, Seoul (KR)

(72) Inventors: Seong-Ju HWANG, Seoul (KR); Xiaoyan JIN, Seoul (KR)

(21) Appl. No.: 18/331,771

(22) Filed: Jun. 8, 2023

(30) Foreign Application Priority Data
Jun. 9, 2022 (KR) 10-2022-0070047
Jun. 9, 2022 (KR) 10-2022-0070048

(51) Int. Cl. C25B 11/075

(52) U.S. Cl. CPC C25B 11/075

(57) ABSTRACT

Proposed are an electrochemical catalyst that can replace platinum by being implemented into a two-dimensional metal nanosheet with a high specific surface area to fully use metal catalyst materials and metal phosphide catalyst materials with excellent electrical conductivity, simultaneously having a simple manufacturing process to facilitate mass synthesis to be capable of implementing an ultra-thin film and a large area to maximize the utilization of catalysts, and a manufacturing method thereof.

### BACKGROUND OF THE INVENTION

### Field of the Invention

The present invention relates to an electrochemical catalyst and a method of manufacturing the same, and more particularly, to an electrochemical catalyst that can significantly improve a specific surface area capable of performing a catalytic reaction by implementing an electrochemical catalyst as a two-dimensional nanosheet and simultaneously additionally forming holes or active sites in the surface and that has a simple manufacturing process to facilitate mass synthesis and to be capable of implementing an ultra-thin film and a large area, and a method of manufacturing the same.

### Description of the Related Art

As the world's population increases, the use of fossil fuels has continuously increased, but such fossil fuels emit substances such as carbon dioxide that adversely affect global warming and have problems with reserve depletion, and thus research on alternative energy sources has been continued. Accordingly, hydrogen, which has high energy density and is environmentally friendly, has been introduced as a substitute for fossil fuels. Platinum is mainly used as electrochemical catalysts used to produce such hydrogen, but has disadvantages of low energy efficiency and high price, so it is required to develop an electrochemical catalyst that is readily available and highly active to replace platinum.

Accordingly, various electrochemical catalysts are being studied. In particular, metal catalyst materials have more excellent electrical conductivity than other compounds, and thus are in the spotlight as electrochemical catalysts that can replace platinum. However, in the case of electrochemical metal catalysts introduced so far, the utilization thereof is limited due to the following problems.

First, metal catalyst materials reported so far include Fe, Ru, Co, Ni, Rh, and the like, and metal phosphide catalyst materials reported so far include iron phosphide, cobalt phosphide, nickel phosphide, titanium phosphide, and the like. However, when these metal catalyst materials and metal phosphides are manufactured as electrochemical catalysts, there is a problem in that the manufactured electrochemical catalysts do not exhibit catalytic efficiency sufficient to replace platinum.

Recently, it has been confirmed that among various metal phosphides, ruthenium phosphide has the best catalytic activity compared to other metal phosphides, and it has been confirmed that ruthenium phosphide has an activity comparable to that of a platinum catalyst.

More specifically, in general, since electrochemical catalysts exhibit activity mainly through surface reactions, studies that can increase the contact area with the reactants, that is, the specific surface area, should be supported due to the nature of these catalytic reactions. However, there is no choice but to manufacture the electrochemical catalysts using ruthenium phosphide catalyst material in the related art into zero-dimensional particles or one-dimensional nanorods, so there is a problem that the excellent electrical conductivity of the metal phosphide catalyst materials cannot be maximized for sufficient utilization.

Second, in order to solve the above problems, an attempt has been made to improve the specific surface area by manufacturing an electrochemical catalyst having a two-dimensional nanosheet shape rather than a zero-dimensional particle or a one-dimensional nanorod shape. However, the experimental process is complicated and mass synthesis is difficult to exhibit a significant limitation in practical application. Further, even if an electrochemical catalyst using a metal catalyst material or a metal phosphide catalyst material is implemented into a two-dimensional nanosheet shape, the thickness of the nanosheet has to be manufactured to be thicker than several tens of nanometers, and the size thereof is also several nanometers or more, so there is a problem that it is difficult to implement an ultra-thin nanosheet.

Third, studies in the related art using metal phosphide catalyst materials have difficulties in maximizing catalytic efficiency due to the intrinsic properties of metals. That is, as described above, it is difficult to implement a metal phosphide catalyst material into a thin nanosheet, and even if a thin metal phosphide catalyst material is implemented, no research has been reported on maximizing catalytic efficiencies by controlling factors that greatly affect catalytic activities. For example, there is no research on developing catalyst materials that can maximize catalytic activities, such as holes or additional surface active sites that can improve the specific surface area, and thus utilization thereof is reduced.

Accordingly, research is urgently needed on an electrochemical catalyst that can be implemented as a two-dimensional nanosheet with a high specific surface area so that metal catalyst materials and metal phosphide catalyst materials with excellent electrical conductivity can be sufficiently used and, simultaneously, that has a simple manufacturing process to facilitate mass synthesis and to be capable of implementing an ultra-thin film and a large area to maximize the utilization of catalysts.

### SUMMARY OF THE INVENTION

The object of the present invention to solve the problems described above is to provide an electrochemical catalyst that can replace platinum by being implemented into a form of a two-dimensional metal nanosheet with a high specific surface area to fully use the characteristics of a metal catalyst material with excellent electrical conductivity and simultaneously by having a simple manufacturing process to facilitate mass synthesis and to be capable of implementing an ultra-thin film and a large area so that the utilization of catalysts is maximized.

Another object of the present invention is to provide an electrochemical catalyst that can significantly improve a specific surface area capable of performing a reaction by implementing an electrochemical catalyst into a two-dimensional metal nanosheet so as to fully use a metal catalyst material with excellent electrical conductivity and, simultaneously, by additionally forming holes or active sites in the surface and that can replace platinum by having a simple manufacturing process to facilitate mass synthesis and to be capable of implementing an ultra-thin film and a large area, and a manufacturing method thereof.

The problem to be solved by the present invention is not limited to the problems mentioned above, and other problems that are not mentioned will be clearly understood by those skilled in the art from the description below.

In order to solve the above problems, the present invention provides a method of manufacturing an electrochemical catalyst including: (1) a step of preparing a metal oxide nanosheet precursor; and (2) a step of heat-treating the metal oxide nanosheet precursor in a hydrogen and argon gas atmosphere to manufacture a two-dimensional metal nanosheet.

In addition, according to an embodiment of the present invention, the step (2) may be a step of forming holes in a surface of the two-dimensional metal nanosheet.

In addition, the metal oxide nanosheet precursor in the step (1) may be derived from metal selected from the group consisting of Re, V, Os, Ru, Ta, Ir, Nb, W, Ga, Mo, In, Cr, Rh, Mn, Co, Fe, Au, Cu, and Ag or any one or more selected from the group consisting of alloys thereof or may be derived from any one or more selected from the group consisting of metal oxide including ruthenium oxide, vanadium oxide, manganese oxide, cobalt oxide, or a combination thereof.

In addition, the step (2) may be a step in which the heat treatment is performed at 100° C. to 700° C.

In addition, the step (2) may be a step in which the heat treatment is performed in a hydrogen and argon gas atmosphere of 1% to 99%.

In addition, the present invention provides an electrochemical catalyst including a surface having holes therein and two-dimensional metal nanosheets.

In addition, the two-dimensional metal nanosheet may be derived from metal selected from the group consisting of Re, V, Os, Ru, Ta, Ir, Nb, W, Ga, Mo, In, Cr, Rh, Mn, Co, Fe, Au, Cu, and Ag or any one or more selected from the group consisting of alloys thereof or may be derived from any one or more selected from the group consisting of metal oxide including ruthenium oxide, vanadium oxide, manganese oxide, cobalt oxide, or a combination thereof.

In addition, a thickness of the two-dimensional metal nanosheet may be 0.01 to 10 nm.

In addition, a size of the two-dimensional metal nanosheet may be 1 to 10,000 nm.

In addition, the electrochemical catalyst may be used as a catalyst in hydrogen evolution reaction (HER).

In addition, in order to solve the above problems, the present invention provides a method of manufacturing an electrochemical catalyst including: (1) a step of preparing a metal oxide nanosheet precursor; and (2) a step of subjecting the metal oxide nanosheet precursor to phosphorization reaction to manufacture a two-dimensional metal phosphide nanosheet.

In addition, according to an embodiment of the present invention, the step (2) may be a step of forming holes penetrating the two-dimensional metal phosphide nanosheet.

In addition, in the step (2), heat treatment may be performed in nitrogen gas atmosphere at 300° C. to 600° C.

In addition, the step (2) may be a step of forming a phosphorus (P)-lattice defect.

In addition, the metal oxide nanosheet precursor in the step (1) may be derived from metal selected from the group consisting of Re, V, Os, Ru, Ta, Ir, Nb, W, Ga, Mo, In, Cr, Rh, Mn, Co, and Fe, or an alloy thereof.

In addition, the metal oxide nanosheet precursor may have a layered structure stacked by hydrogen ions.

In addition, the present invention provides an electrochemical catalyst including a two-dimensional metal phosphide nanosheet having a phosphorus (P)-lattice defect.

In addition, according to an embodiment of the present invention, holes penetrating the nanosheet may be further formed.

In addition, a thickness of the two-dimensional metal phosphide nanosheet may be 0.01 to 1 nm.

In addition, a size of the two-dimensional metal phosphide nanosheet may be 1 to 10,000 nm.

In addition, the electrochemical catalyst may be used as a catalyst in a hydrogen evolution reaction (HER).

### BRIEF DESCRIPTION OF THE DRAWINGS

FIG. 1 is a scanning electron microscopy (SEM) image showing a two-dimensional metal nanosheet according to the present invention;

FIG. 2 is a graph showing results of X-ray diffraction pattern analysis of the two-dimensional metal nanosheet according to the present invention;

FIGS. 3 and 4 are transmission electron microscopy (TEM) images showing a two-dimensional metal nanosheet according to the present invention;

FIGS. 5A and 5B are graphs showing results of X-ray absorption near edge structure (XANES) (FIG. 5A) and extended X-ray absorption fine structure (EXAFS) (FIG. 5B) of the two-dimensional metal nanosheet according to the present invention;

FIG. 6 is a graph showing results of HER catalytic activity of the two-dimensional metal nanosheet according to the present invention;

FIG. 7 is a schematic diagram showing a process of manufacturing a two-dimensional metal phosphide nanosheet according to the present invention;

FIG. 8 is a SEM image showing a two-dimensional metal phosphide nanosheet according to the present invention;

FIG. 9 is (a) TEM and (b) atomic force microscopy (AFM) images showing a two-dimensional metal phosphide nanosheet according to the present invention;

FIG. 10 is a graph showing results of X-ray diffraction pattern analysis of the two-dimensional metal phosphide nanosheet according to the present invention;

FIG. 11 is a graph showing XANES/EXAFS results of the two-dimensional metal phosphide nanosheet according to the present invention; and

FIGS. 12A to 12D are graphs showing currents (FIGS. 12A and 12B) and catalytic efficiencies (FIGS. 12C and 12D) in two types of electrolytes in a hydrogen evolution reaction of the two-dimensional metal phosphide nanosheet according to the present invention.

### DETAILED DESCRIPTION OF THE PREFERRED EMBODIMENTS

Hereinafter, preferred embodiments of the present invention in which the above-described problem to be solved can be implemented in detail are described with reference to the accompanying drawings. In describing the present embodiments, the same name and the same reference numeral may be used for the same configuration, and additional description accordingly may be omitted.

As described above, electrochemical catalysts in the related art using excellent electrical conductivity of metal catalyst materials and metal phosphide catalyst materials have difficulties in increasing the specific surface area, complicated manufacturing processes, and difficulties in mass production, and thus there are limitations in practical use.

Accordingly, the present invention provides a method of manufacturing an electrochemical catalyst, including: (1) a step of preparing a metal oxide nanosheet precursor; and (2) a step of heat-treating the metal oxide nanosheet precursor in a hydrogen and argon gas atmosphere to manufacture a two-dimensional metal nanosheet so as to seek solutions to the above problems.

In addition, the present invention provides a method of manufacturing an electrochemical catalyst, including: (a) a step of preparing a metal oxide nanosheet precursor; and (b) a step of subjecting the metal oxide nanosheet precursor to phosphorization reaction to manufacture a two-dimensional metal phosphide nanosheet so as to seek solutions to the above problems.

Through this, the present invention can manufacture an electrochemical catalyst that can be implemented into a two-dimensional nanosheet with a high specific surface area so that metal catalyst materials and metal phosphide catalyst materials with excellent electrical conductivity can be sufficiently used and, simultaneously, that can replace platinum since the manufacturing process is simple to facilitate mass synthesis and to be capable of implementing an ultra-thin film and a large area.

According to the present invention, a nanosheet may be a two-dimensional nanomaterial having a certain area, not a particle or rod shape, and having a nanoscale dimension in thickness, for example, a thickness of 100 nm or less.

Hereinafter, a method of manufacturing an electrochemical catalyst according to the present invention is specifically described.

The method of manufacturing an electrochemical catalyst according to the present invention includes: (1) a step of preparing a metal oxide nanosheet precursor; and (2) a step of heat-treating the metal oxide nanosheet precursor in a hydrogen and argon gas atmosphere to manufacture a two-dimensional metal nanosheet.

The step (1) of the present invention is a step of manufacturing a metal oxide nanosheet precursor in order to use an excellent electrical conductivity of the metal catalyst material.

Generally, the metal catalyst material has more excellent electrical conductivity than other compounds and thus is in the spotlight as an electrochemical catalyst that can replace platinum. Such a metal catalyst material may be metal selected from the group consisting of Re, V, Os, Ru, Ta, Ir, Nb, W, Ga, Mo, In, Cr, Rh, Mn, Co, Fe, Au, Cu, and Ag or any one or more selected from the group consisting of alloys thereof, or may be any one or more selected from the group consisting of metal oxide including ruthenium oxide, vanadium oxide, manganese oxide, cobalt oxide, or a combination thereof. In an embodiment according to the present invention, the metal catalyst precursor material may include RuO₂, MnO₂, Mn₃O₇, Mn₁₋ₓCoₓO₂ (0<x≤VO₂, CoO₂, FeO₂, ReO₂, IrO₂, InO, or a combination thereof.

In the step (1) of manufacturing a metal oxide nanosheet precursor by using the metal catalyst material, a generally well-known method of manufacturing a metal oxide nanosheet may be used as long as the method meets the purpose of the present invention. In a non-limiting example of the method, a metal oxide nanosheet precursor can be manufactured by sufficiently stirring materials including the metal catalyst material, oxide of the metal catalyst material, and sodium, performing a heat treatment for 10 hours or more at a temperature of 600° C. to 1,200° C. in an inert atmosphere such as a nitrogen atmosphere, an argon atmosphere, or vacuum to obtain metal oxide, then performing an acid treatment to synthesize a hydrogen ion-substituted derivative, and then by stripping in an aqueous solution.

Meanwhile, the metal oxide nanosheet precursor stacked by hydrogen ions may have a layered structure. According to a preferred embodiment of the present invention, when the metal catalyst material is ruthenium oxide, the metal oxide nanosheet precursor may be a ruthenium oxide precursor and may have a RuO₂—RuO₂ layered structure.

Then, the step (2) is a step of heat-treating the metal oxide nanosheet precursor in a hydrogen and argon gas atmosphere to manufacture a two-dimensional metal nanosheet.

Generally, as described above, examples of the metal catalyst material include Fe, Ru, Co, Ni, and Rh. When these metal catalyst materials are manufactured into electrochemical catalysts, there is a problem in that catalytic efficiencies sufficient to replace platinum are not exhibited. More specifically, since the electrochemical catalyst mainly exhibits activity through a surface reaction, support by research for increasing a contact area with a reactant, that is, specific surface area is required due to the nature of such catalytic reactions. However, there is no choice but to manufacture an electrochemical catalyst obtained by using the metal catalyst material in the related art into a zero-dimensional particle or a one-dimensional nanorod shape. Therefore, there is a problem in that excellent electrical conductivities of the metal catalyst materials cannot be maximized and fully utilized.

Also, the metal catalyst materials tend to agglomerate due to the nature of the metal particles, and thus problems of reducing the accessible surface area and catalytic activity may be caused. When an electrochemical catalyst is manufactured by manufacturing metal in the related art in a nano size, there is a problem in that these materials are not uniformly mixed, and thus the catalytic activity is not sufficiently exhibited. Therefore, utilization thereof is greatly reduced.

According to the present invention, a two-dimensional nanosheet form can be manufactured while preventing agglomeration of particles and simultaneously maximizing a specific surface area to greatly improve the catalytic efficiency.

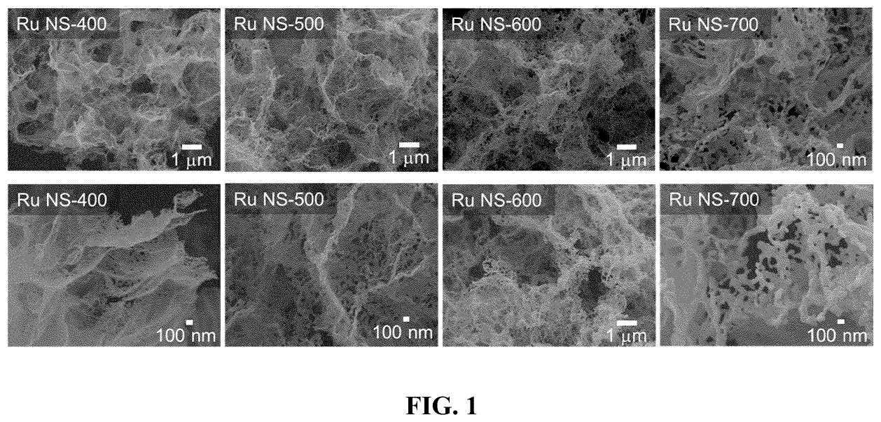

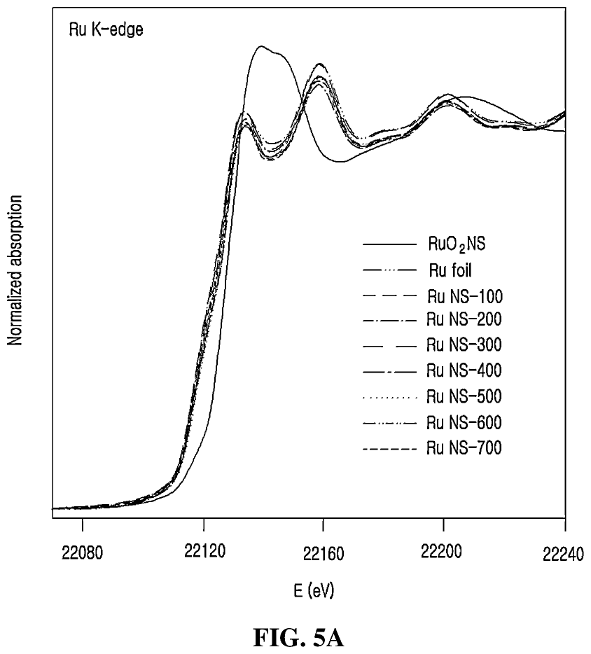

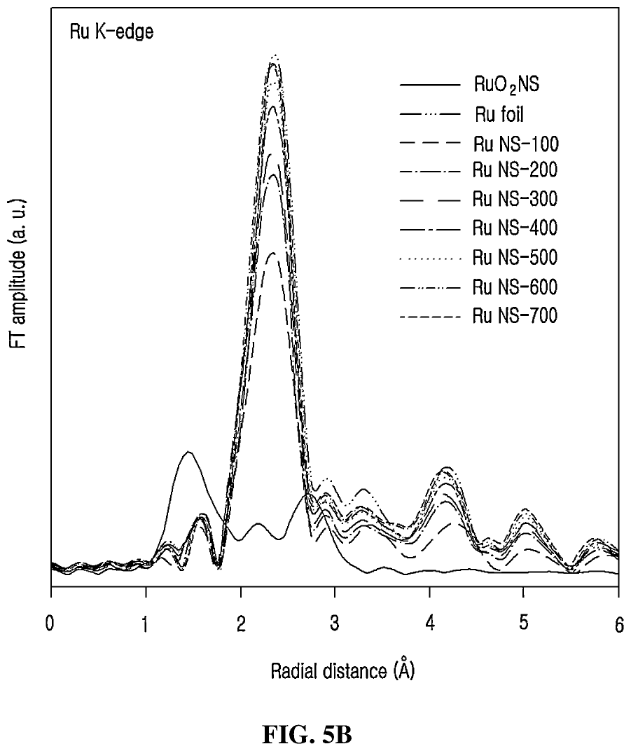

More specifically, with reference to FIG. 1, according to the preferred embodiment of the present invention, it can be understood that ruthenium oxide that is a metal nanosheet precursor has a two-dimensional nanosheet shape, and it is understood that a ruthenium nanosheet that is an electrochemical catalyst manufactured accordingly also has a two-dimensional nanosheet shape. Similarly, with reference to FIGS. 5A and 5B, it is confirmed that a complete phase transition from the ruthenium oxide nanosheet that is the precursor into a pure ruthenium metal phase has been occurred from the results of XANES (FIG. 5A) and EXAFS (FIG. 5B).

That is, since the electrochemical catalyst according to the present invention has a two-dimensional nanosheet shape instead of a zero-dimensional particle or one-dimensional nanorod shape, all constituent elements can participate in the reaction so that the reaction specific surface area can be widened accordingly, and thus the catalytic efficiency of the metal catalyst material can be maximized.

To this end, in the step (2), a heat treatment may be performed at a temperature of 100° C. to 700° C. in a hydrogen and argon gas atmosphere. Through the heat treatment, the metal oxide nanosheet precursor manufactured in the step (1) is reduced under a hydrogen reaction, and thus a two-dimensional metal nanosheet composed only of pure metal can be obtained.

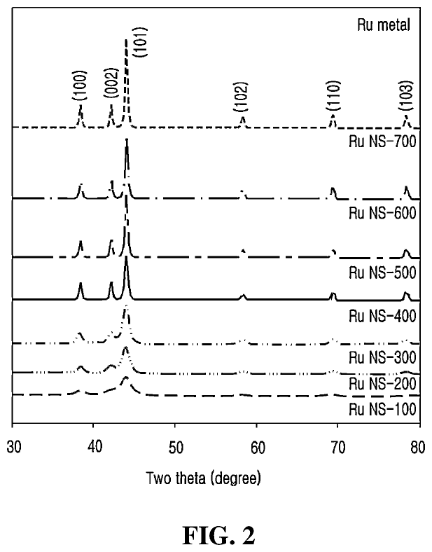

More specifically, with reference to FIG. 2, it can be understood that all the two-dimensional ruthenium nanosheets obtained by synthesizing ruthenium oxide into a metal oxide nanosheet precursor according to the preferred embodiment of the present invention at a heat treatment temperature from 100 to 700 degrees are synthesized to pure ruthenium (Ru) metal having an hcp structure. At this time, if the heat treatment temperature in the step (2) is less than 100° C., there may be a problem in that the metal oxide nanosheet precursor is not sufficiently reduced. In addition, if the heat treatment temperature in the step (2) exceeds 700° C., the heat treatment temperature is high, and thus there may be a problem in that too large holes are formed in the surface of the nanosheets so that the shape of the nanosheets may not be maintained.

In addition, the step (2) may be a step in which heat treatment is performed in a hydrogen and argon gas atmosphere of 1% to 99%. At this time, if hydrogen and argon gas of less than 1% is used, there may be a problem in that the metal oxide nanosheet is not sufficiently reduced and thus cannot be synthesized into a metal nanosheet.

Meanwhile, according to the present invention, the two-dimensional metal nanosheet shape as described above can be implemented under the heat treatment conditions in the step (2), and simultaneously, an electrochemical catalyst having an ultra-thin film/large area can be manufactured. That is, in the related art, there is no choice but to manufacture a metal nanosheet to be used as an electrochemical catalyst to cause the thickness to be as thick as several tens of nanometers, and thus an ultra-thin sheet structure cannot not be implemented. Also, there is no choice but to manufacture a metal nanosheet to cause the size to be in an area of about several nanometers and to have limitation in improving a specific surface area, so there is a problem in that catalytic efficiency cannot be maximized. In addition, when catalytic activity increasing metal is manufactured into a form of a nano-sized sheet in the related art, there are not enough reaction sites for hydrogen to react to have a problem in that the catalytic activity is deteriorated, and thus there is difficulty in utilization as an electrochemical catalyst.

In contrast, according to the present invention, as shown in FIGS. 1 and 2, in the step (2), the metal nanosheet can be manufactured in the thickness of 0.01 to 10 nm and is preferably manufactured in the thickness of 0.01 to 1 nm. The size of the metal nanosheet can be implemented in a large area of 1 to 10,000 nm, preferably 100 to 10,000 nm. Therefore, the specific surface area that greatly affects the catalytic efficiency as the electrochemical catalyst can be significantly increased.

In addition, according to the present invention, in the step (2), holes are formed in the surface of the two-dimensional metal nanosheet to solve the above-described problem in the catalytic activity. That is, all constituent elements of the electrochemical catalyst according to the present invention are exposed on the surface, and thus contact with a reactant in the catalytic reaction mainly involving surface reaction increases, so the reactivity can be significantly improved.

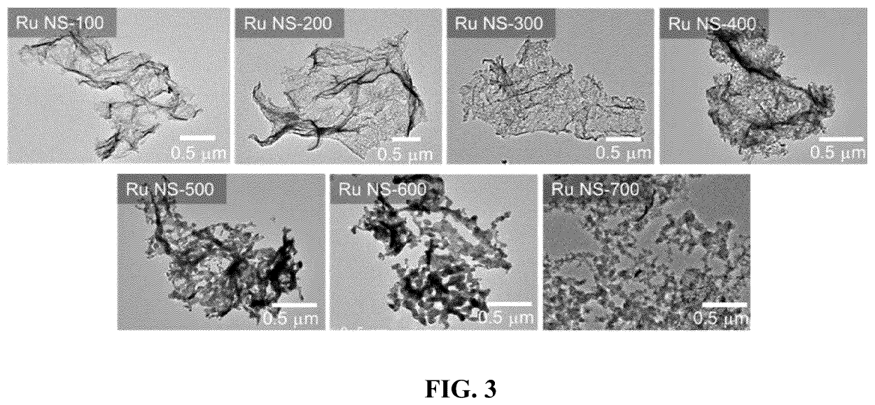

More specifically, with reference to FIG. 3, it can be understood that all the electrochemical catalysts manufactured by varying temperature conditions according to the present invention exhibit two-dimensional nanosheet shapes and have holes. That is, since the two-dimensional nanosheet according to the present invention not only can implement two-dimensional nanosheet shape but also can form holes in the surface of the two-dimensional nanosheet by the heat treatment in the hydrogen and argon gas atmosphere in the step (2), the effect of increasing the specific surface area by the holes can be further improved.

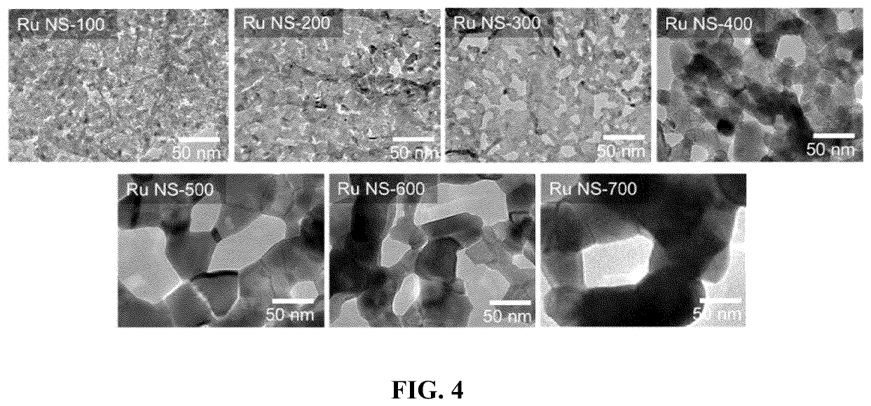

Additionally, the present invention can control the catalytic efficiency by controlling the size of the holes to be appropriate for the use of the electrochemical catalyst according to the present invention. More specifically, with reference to FIGS. 3 and 4, it is possible to confirm that the size of the holes in the surface of the nanosheet increases as the heat treatment temperature increases.

As a result, according to the present invention, it is possible to implement the two-dimensional nanosheet shape of the ultra-thin film/large area that can optimize the specific surface area of the electrochemical catalyst by the heat treatment step under the hydrogen and argon gas atmosphere in the step (2), and it is further possible to maximize the efficiency of the catalyst by forming holes in the surface of the two-dimensional nanosheet and controlling the size thereof.

Further, by solving the problem of a metal nanosheet in the related art in that the experiment process is complicated and the mass synthesis is difficult, it is possible to manufacture the two-dimensional nanosheet in a simple step of performing the heat treatment under a specific temperature condition so that the economic feasibility and the utilization can be greatly improved.

The electrochemical catalyst according to the present invention is described. However, in order to avoid redundancy, descriptions of parts having the same technical idea as the method of manufacturing an electrochemical catalyst are omitted.

The electrochemical catalyst according to the present invention has holes in the surface and includes the two-dimensional metal nanosheet having a hexagonal close-packed (HCP) crystal structure.

The two-dimensional metal nanosheet may be derived from metal selected from the group consisting of Re, V, Os, Ru, Ta, Ir, Nb, W, Ga, Mo, In, Cr, Rh, Mn, Co, Fe, Au, Cu, and Ag or any one or more selected from the group consisting of alloys thereof or may be derived from any one or more selected from the group consisting of metal oxide including ruthenium oxide, vanadium oxide, manganese oxide, cobalt oxide, or a combination thereof.

In addition, the two-dimensional nanosheet may be manufactured in the thickness of to 10 nm or is preferably manufactured in the thickness of 0.01 to 1 nm. Also, the two-dimensional metal nanosheet may be implemented into a large area of 1 to 10,000 nm, preferably 100 to 10,000 nm.

Such an electrochemical catalyst according to the present invention may be used as a catalyst in a hydrogen evolution reaction (HER).

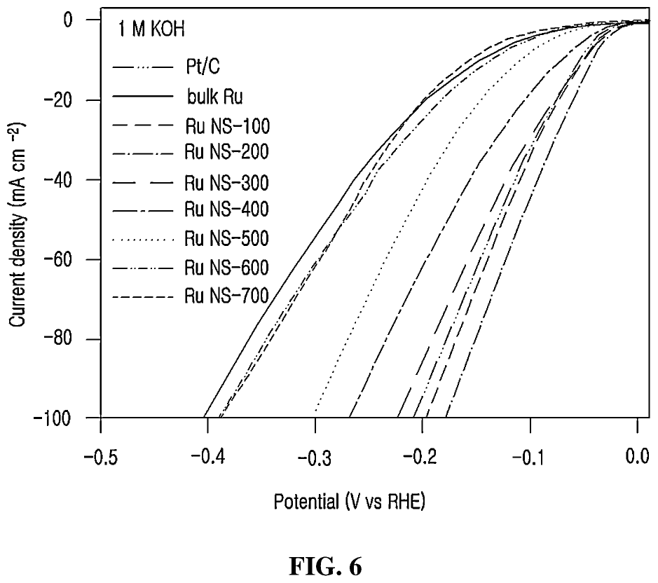

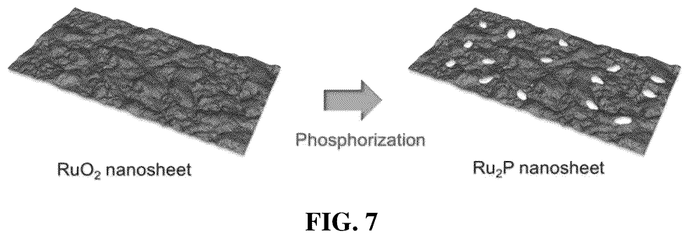

More specifically, with reference to FIG. 6, it can be understood that the synthesized two-dimensional ruthenium nanosheet may have hydrogen evolution catalytic activity more significantly excellent than ruthenium particles in a bulk state, and particularly, the two-dimensional ruthenium nanosheet synthesized at 100° C. to 300° C. can exhibit the catalytic activity similar to that of a platinum catalyst.

As a result, it can be understood that, according to the present invention, it is possible to manufacture an electrochemical catalyst that can implement a two-dimensional nanosheet having a high specific surface area so that a metal catalyst material with excellent electrical conductivity can be sufficiently used and, simultaneously, that can replace platinum by having a simple manufacturing process to facilitate mass synthesis and implementing an ultra-thin film or a large area to maximize the utilization of a catalyst.

Another method of manufacturing an electrochemical catalyst according to the present invention includes: (a) a step of preparing a metal oxide nanosheet precursor, and (b) a step of subjecting the metal oxide nanosheet precursor to phosphorization reaction to manufacture a two-dimensional metal phosphide nanosheet.

The step (a) according to the present invention is a step of manufacturing the metal oxide nanosheet precursor in order to use excellent electrical conductivity of the metal phosphide catalyst material.

Generally, a metal phosphide catalyst material has more excellent electrical conductivity than other compounds and thus is in the spotlight as an electrochemical catalyst that can replace platinum. Such a metal phosphide material may be metal selected from the group consisting of Re, V, Os, Ru, Ta, Ir, Nb, W, Ga, Mo, In, Cr, Rh, Mn, Co, and Fe and any one or more selected from the group consisting of alloys thereof. In an embodiment according to the present invention, the metal phosphide precursor material may include RuO₂, MnO₂, Mn₃O₇, Mn₁₋ₓCoₓO₂ (0<x≤0.4), VO₂, CoO₂, FeO₂, ReO₂, IrO₂, InO, or a combination thereof.

As the step (a) of manufacturing the metal oxide nanosheet precursor by using the metal catalyst material, a general well-known method of manufacturing a metal oxide nanosheet may be used as long as the method meets the purpose of the present invention. In a non-limiting example of the method, a metal oxide nanosheet precursor can be manufactured by sufficiently stirring materials including the metal catalyst material, oxide of the metal catalyst material, and sodium, performing a heat treatment for 10 hours or more at a temperature of 600° C. to 1,200° C. in an inert atmosphere such as a nitrogen atmosphere, an argon atmosphere, or vacuum to obtain sodium metal oxide, then performing an acid treatment to synthesize a hydrogen ion-substituted derivative, and then by stripping in an aqueous solution.

Meanwhile, the metal oxide nanosheet precursor stacked by hydrogen ions may have a layered structure. According to a preferred embodiment of the present invention, when the metal catalyst material is ruthenium oxide, the metal oxide nanosheet precursor may be a ruthenium oxide precursor and may have a RuO₂—RuO₂ layered structure.

Then, the step (b) is a step of subjecting the metal oxide nanosheet precursor to phosphorization reaction to manufacture a two-dimensional metal phosphide nanosheet.

Generally, since the electrochemical catalyst mainly exhibits activity through a surface reaction, the catalytic efficiency can be maximized by increasing a contact area with a reactant, that is, specific surface area due to the nature of such catalytic reactions. However, an electrochemical catalyst obtained by using the metal catalyst material in the related art can be manufactured only into a zero-dimensional particle or a one-dimensional nanorod shape due to technical limitation, and it is difficult to manufacture a massive amount of ultra-thin nanosheet-shaped catalysts.

Also, the catalyst materials tend to agglomerate due to the nature of the particles, and thus problems of reducing the accessible surface area and catalytic activity may be caused. When an electrochemical catalyst is manufactured by manufacturing metal in the related art in a nano size, there is a problem in that these materials are not uniformly mixed, and thus the catalytic activity is not sufficiently exhibited.

As a result, the present invention implements an electrochemical catalyst in a two-dimensional nanosheet shape that can prevent agglomeration of nano-sized metal particles and increase the specific area by the heat treatment step in the step (b) to solve the above-described problems and also greatly improve the catalytic efficiency.

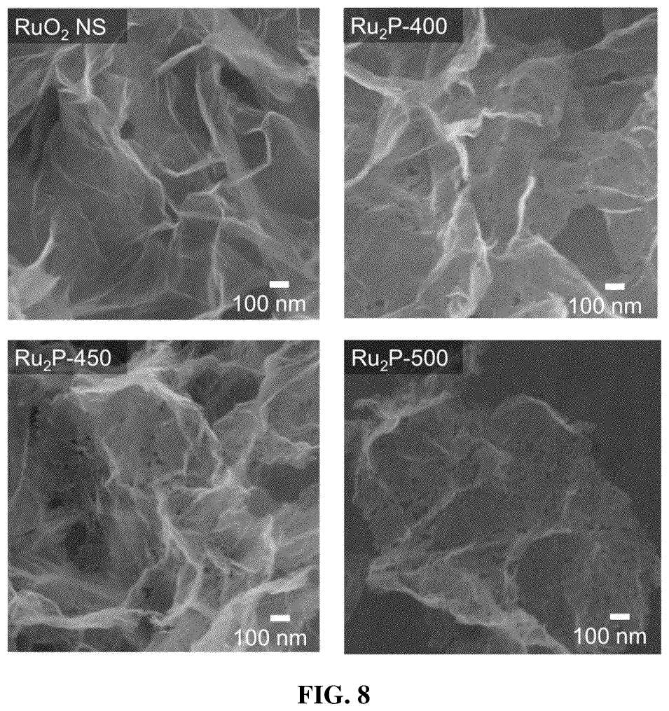

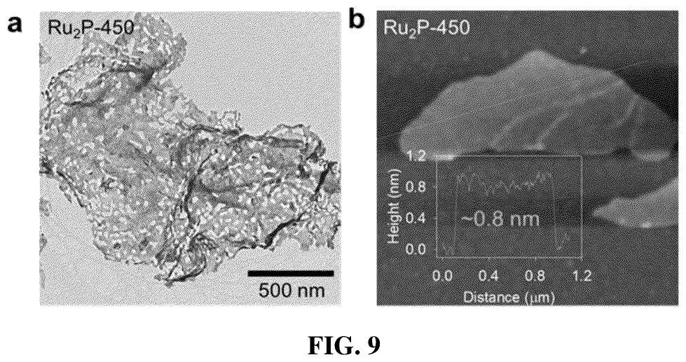

More specifically, with reference to FIGS. 8 and 9, it can be understood that very thin ruthenium phosphide nanosheets having a two-dimensional structure are formed when ruthenium oxide that is a metal phosphide nanosheet precursor is used according to the preferred embodiment of the present invention. That is, since the electrochemical catalyst according to the present invention has a two-dimensional nanosheet shape, not a zero-dimensional particle or a one-dimensional nanorod shape, all constituent elements can participate in the reaction, so the reaction specific surface area can be widened accordingly, and thus the catalytic efficiency of the metal catalyst material can be maximized. That is, with reference to FIGS. 8 and 9, in the step (b), the two-dimensional nanosheet can be manufactured in the thickness of 0.01 to 10 nm and is preferably manufactured in the thickness of 0.01 to 1 nm. Also, the two-dimensional metal nanosheet may be implemented into a large area of 1 to 10,000 nm and preferably 100 to 10,000 nm. Therefore, the specific surface area that greatly affects the catalytic efficiency as the electrochemical catalyst can be significantly increased.

For this, in the step (b), the heat treatment can be performed in the nitrogen gas atmosphere at 300° C. to 600° C., preferably at 350° C. to 550° C., and more preferably at 400° C. to 500° C.

At this time, if the heat treatment temperature is less than 300° C., the heat treatment temperature is too low, and thus a problem that the metal oxide nanosheet precursor obtained in the step (a) cannot be sufficiently phase-transitioned into the metal phosphide nanosheet may occur. Also, if the heat treatment temperature exceeds 600° C., since too large holes are formed in the surface of the nanosheet and the particle size increases due to sintering effect caused by high temperature, nanoparticles configuring the metal phosphide nanosheet agglomerate to cause a problem of greatly reducing accessible surface area and catalytic activity.

Meanwhile, according to the present invention, the two-dimensional metal phosphide nanosheet shape as described above can be implemented by the heat treatment conditions in the step (b), and additionally, the electrochemical catalyst having holes or having additional surface active site ultra-thin film/large area that can improve the specific surface area can be manufactured.

Generally, there is limitation in implementing a metal phosphide catalyst material into a thin nanosheet, and even if the thin nanosheet is implemented, there is problem that it is difficult to maximize the catalytic efficiency by controlling factors that greatly affect the catalytic activity. For example, no research that can maximize the catalytic activity by forming holes or additional surface active sites that can improve the specific surface area capable of performing the catalytic reaction is introduced, and thus the utilization on the electrochemical catalyst by using the metal phosphide catalyst material is reduced.

Therefore, the present invention can implement the two-dimensional nanosheet shape by the heat treatment of the step (b) and, simultaneously, can significantly improve the catalytic efficiency by forming surface holes penetrating the nanosheet and a phosphorus (P)-lattice defect.

More specifically, with reference to FIGS. 8 and 9, it is confirmed that the ruthenium oxide nanosheet does not have holes, but it can be understood that holes penetrating the surface of the nanosheet is formed in case of the electrochemical catalyst according to the present invention obtained by performing the step (b) by varying temperatures. That is, holes can be formed in the surface of the two-dimensional nanosheet according to the heat treatment condition of the step (b), and the catalytic efficiency can be greatly enhanced by increasing the specific surface area capable of performing the catalytic reaction by these holes.

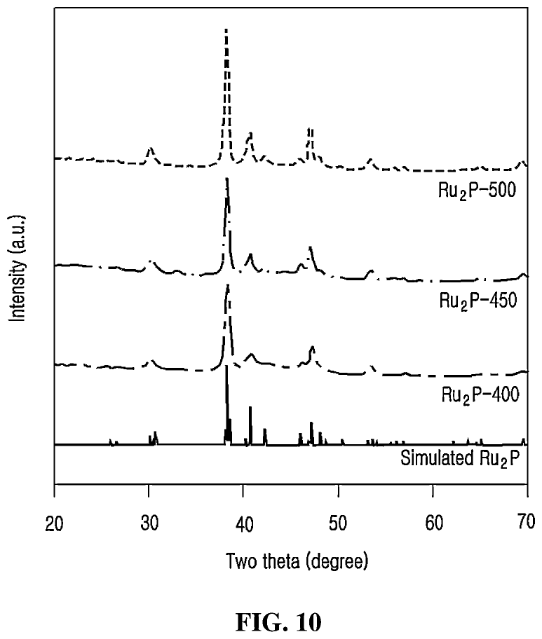

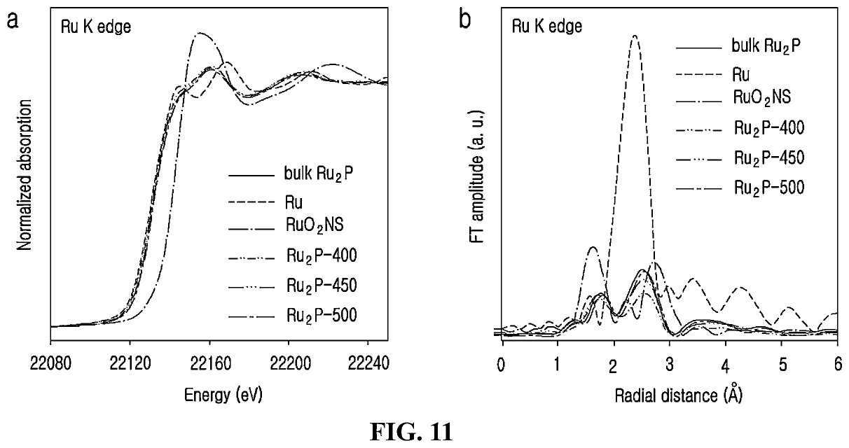

Also, with reference to FIGS. 10 and 11, it is confirmed that all the ruthenium phosphide nanosheets manufactured according to the embodiment of the present invention have Ru₂P crystal phases without impurities through comparison with the theoretical X-ray diffraction patterns of ruthenium phosphide. Also, it can be confirmed that a complete phase transition has occurred in the ruthenium oxide nanosheet, that is a precursor, by the heat treatment. In addition, since the FT-EXAFS shape are similar when compared to Ru₂P nanoparticles in a bulk state, it can be understood that pure ruthenium phosphide nanosheets are formed without the formation of other crystal phases.

Also, with reference to Table 1 below, the phosphorus-lattice defect can be confirmed since all coordination numbers of Ru—P bonds obtained by EXAFS fitting analysis are smaller than theoretical coordination numbers. Such a phosphorus-lattice defect serves as an active site capable of performing a catalytic reaction to further improve the catalytic efficiency.

For this, the heat treatment of the step (b) may be a step of phosphorizing the metal oxide manufactured in the step (a) in the range of the above-described temperature range. The phosphorization may be a well-known general phosphorization step that meets the purpose of the present invention, and preferably the phosphorization may be performed by performing a gas phase reaction with NaH₂PO₄·H₂O under the nitrogen gas heat treatment.

Next, another electrochemical catalyst according to the present invention is described. Meanwhile, in order to avoid redundancy, descriptions of parts having the same technical idea as the method of manufacturing an electrochemical catalyst are omitted.

The other electrochemical catalyst according to the present invention includes a two-dimensional metal phosphide nanosheet having holes in the surface.

The two-dimensional metal phosphide nanosheet may be derived from metal selected from the group consisting of Re, V, Os, Ru, Ta, Ir, Nb, W, Ga, Mo, In, Cr, Rh, Mn, Co, or Fe or any one or more selected from the group consisting of alloys thereof and may be derived from any one or more selected from the group consisting of metal oxide including ruthenium oxide, vanadium oxide, manganese oxide, cobalt oxide, or a combination thereof.

In addition, the two-dimensional nanosheet may be manufactured in the thickness of to 10 nm and preferably in the thickness of 0.01 to 1 nm, and the two-dimensional metal phosphide nanosheet may be implemented into a large area in the size of 1 to 10,000 nm and preferably 100 to 10,000 nm.

Such an electrochemical catalyst according to the present invention may be used as a catalyst in a hydrogen evolution reaction (HER).

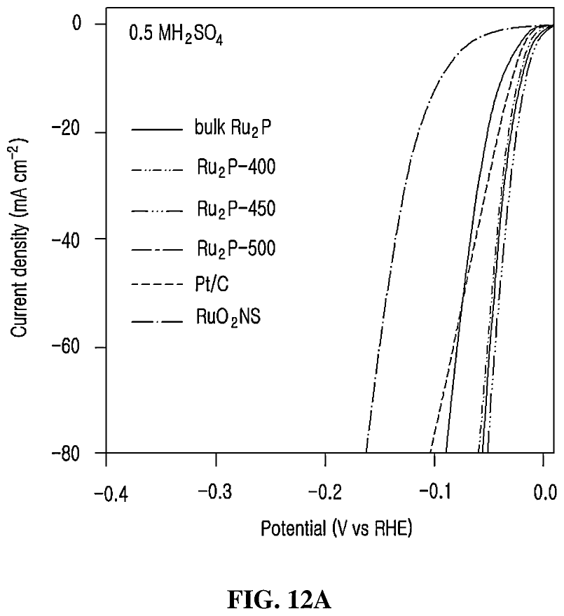

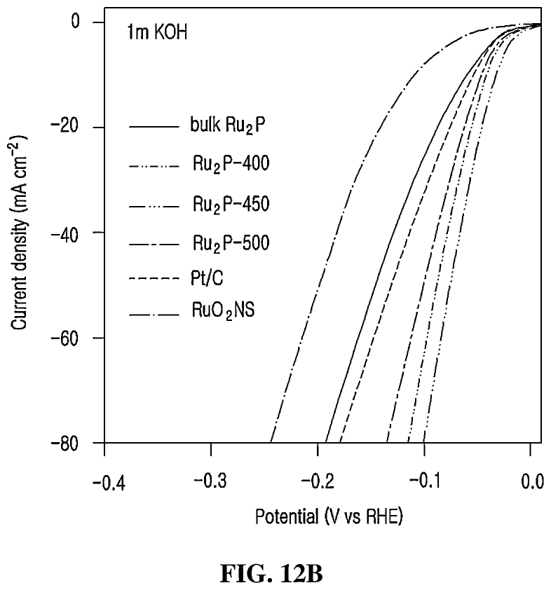

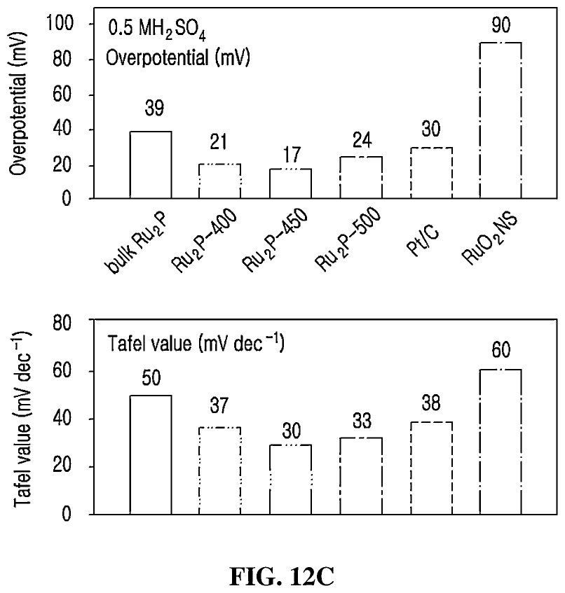

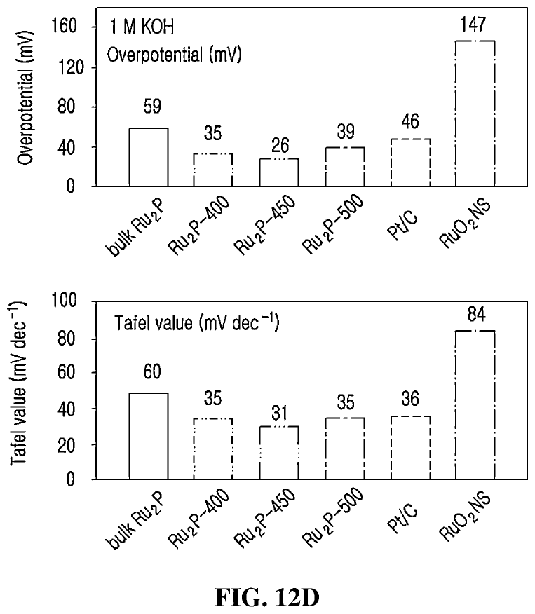

More specifically, with reference to FIGS. 12A to 12D, it can be understood that the synthesized two-dimensional ruthenium phosphide nanosheet exhibits the hydrogen evolution catalytic activity more significantly excellent than ruthenium phosphide particles in a bulk state, and particularly, it can be understood that the two-dimensional ruthenium phosphide nanosheet exhibits more excellent activity than a platinum catalyst.

Accordingly, according to the present invention, it can be understood that it is possible to manufacture an electrochemical catalyst that can implement a two-dimensional nanosheet having a high specific surface area so that a metal catalyst material with excellent electrical conductivity can be sufficiently used and, simultaneously, that can replace platinum by having a simple manufacturing process to facilitate mass synthesis and being capable of implementing an ultra-thin film or a large area to maximize the utilization of a catalyst.

Hereinafter, the present invention is described in more detail through examples, but the following examples are not intended to limit the scope of the present invention, but should be interpreted to aid understanding of the present invention.

### Example 1-1

(1) Manufacturing of Metal Oxide Nanosheet Precursor

0.476 g of Na₂CO₃ (manufactured by DAEJUNG CHEMICALS & METALS), 0.897 g of RuO₂ (manufactured by Alfa Aesar), and 0.227 g of Ru (manufactured by Alfa Aesar) were put into a mortar, were ground, were made into pellets, and were put into an alumina bottle. The alumina bottle was put into a gas furnace, reaction was performed with flowing Ar gas for 12 hours at 900° C. at a temperature increase rate of 100° C. per hour, and the temperature was cooled down to room temperature naturally. 100 ml of 1 M Na₂S₂O₈ (manufactured by Sigma Aldrich) was added per 1 g of a sample synthesized in a solid phase and was reacted at room temperature for 72 hours. Thereafter, an excessive amount of Na₂S₂O₈ was washed off with distilled water and dried in an oven at 50° C. 100 ml of 1M HCl (manufactured by Samchun Chemical Co., Ltd.) was added per 1 g of the dried sample and changed every day while being stirred for three days. Thereafter, 0.5 ml of 40 wt % TBAOH (Tetrabutylammonium hydroxide) (manufactured by Sigma Aldrich) and 125 ml of distilled water were added per 0.5 g of the sample washed with distilled water until neutral and dried and were stirred at room temperature for 10 days. The precipitate was filtered from the synthesized solution by using a centrifuge to synthesize stripped RuO₂ nanosheet.

(2) Manufacturing of Two-Dimensional Metal Nanosheet

The RuO₂ nanosheet obtained in the step (1) was heat-treated for three hours at a 5% H₂/Ar (100 cc) gas atmosphere at the temperature of 100° C. to manufacture a two-dimensional ruthenium nanosheet consisting only of pure ruthenium metal.

### Examples 1-2 to 1-7

Manufacturing was performed in the same manner as in Example 1-1, except for performing the heat treatment with the heat treatment temperatures in the step (2) changed to 100° C. to 700° C.

### Comparative Example 1-1

As a comparative example, the ruthenium oxide nanosheet manufactured in the step (1) of Example 1-1 was prepared instead of a pure ruthenium nanosheet.

Experiment Example 1-1 Hydrogen Evolution Reaction (HER) Performance Measurement.

2 mg of the electrochemical catalyst manufactured in Examples 1-1 to 1-7 and Comparative Example 1-1 was dissolved in a solution of 0.8 ml of deionized water and 0.2 ml of isopropanol (manufactured by Samchun Chemical Co., Ltd.), 20 μl of a 5 wt % Nafion solution (manufactured by Sigma Aldrich) was introduced, and the resultant was dispersed by ultrasonication (JAC-3010 manufactured by Kodo Technical Research Co., Ltd.). 10 μl of the dispersed solution was sampled on a glassy carbon (GC) rotating disk electrode (RDE) (manufactured by ALS Co., Ltd.). An SCE electrode was used as a reference electrode, and Pt wire was used as a counter electrode. The measurement was performed by using a RRDE-3A rotating ring disk electrode apparatus (manufactured by ALS Co., Ltd.) to test the hydrogen evolution reaction catalytic activity in a 1 M KOH electrolyte in which N₂ was purged for 30 minutes or more, and the result is shown in FIG. 6.

With reference to FIG. 6, it can be understood that the synthesized two-dimensional ruthenium nanosheets exhibit a significantly more excellent hydrogen evolution catalytic activity than ruthenium particles in a bulk state, and particularly, it can be understood that the two-dimensional ruthenium nanosheet synthesized at 100° C. to 300° C. exhibit a catalytic activity similar to a platinum catalyst.

### Experiment Example 1-2 X-Ray Diffraction Pattern Analysis

The X-ray diffraction patterns of Examples 1-1 to 1-7 were analyzed (X-ray diffraction by MiniFlex600 manufactured by Rigaku Corporation) and were shown in FIG. 2.

With reference to FIG. 2, it can be understood that the two-dimensional ruthenium nanosheets obtained by synthesizing ruthenium oxide as a metal oxide nanosheet precursor according to the preferred embodiment of the present invention at the heat treatment temperature of 100° C. to 700° C. were all synthesized to pure ruthenium (Ru) metal having an hcp structure.

### Experiment Example 1-3 SEM Images

Scanning electron microscope images (Field Emission-Scanning Electron Microscopy by JSM-7001F manufactured by JEOL Ltd.) of Examples 1-1 to 1-7 and Comparative Example 1-1 were checked and are shown in FIG. 1.

With reference to FIG. 1, it can be understood that ruthenium oxide, which is a metal nanosheet precursor, has a two-dimensional nanosheet shape, and it can be understood that ruthenium nanosheets, which is an electrochemical catalyst manufactured accordingly, also have a two-dimensional nanosheet shape.

### Experiment Example 1-4 TEM Images

Transmission electron microscope images (Transmission electron microscopy by JEM-F200 manufactured by JEOL Ltd.) of Examples 1-1 to 1-7 and Comparative Example 1-1 were checked and are shown in FIGS. 3 and 4.

With reference to FIGS. 3 and 4, it can be understood that the electrochemical catalysts manufactured by varying different temperature conditions according to the present invention all have a two-dimensional nanosheet shape and have holes. That is, it can be understood that the two-dimensional nanosheet according to the present invention can realize a two-dimensional nanosheet shape by the heat treatment under the hydrogen and argon gas atmosphere in the step (2) and also can form holes in the surface of the two-dimensional nanosheet and thus the specific surface area increasing effect by the hole can be further improved.

### Experiment Example 1-5 XANES and EXAFS

X-ray absorption near edge structures (XANES) and extended X-ray absorption fine structures (EXAFS)(Pohang Light Source (PLS)) of Examples 1-1 to 1-7 and Comparative Example 1-1 were measured, and the results thereof are shown in FIGS. 5A and 5B.

With reference to FIGS. 5A and 5B, it can be confirmed that complete phase transitions to pure ruthenium metal phases were occurred in the ruthenium oxide nanosheets, which were the precursors, from the results of XANES (FIG. 5A) and EXAFS (FIG. 5B).

### Example 2-1 (Ru₂P-400)

(a) Manufacturing of Metal Oxide Nanosheet Precursor

0.476 g of Na₂CO₃ (manufactured by DAEJUNG CHEMICALS & METALS), 0.897 g of RuO₂ (manufactured by Alfa Aesar), and 0.227 g of Ru (manufactured by Alfa Aesar) were put into a mortar, were ground, were made into pellets, and were put into an alumina bottle. The alumina bottle was put into a gas furnace, reaction was performed with flowing Ar gas for 12 hours at 900° C. at a temperature increase rate of 100° C. per hour, and the temperature was cooled down to room temperature naturally. 100 ml of 1 M Na₂S₂O₈ (manufactured by Sigma Aldrich) was added per 1 g of a sample synthesized in a solid phase and was reacted at room temperature for 72 hours. Thereafter, an excessive amount of Na₂S₂O₈ was washed off with distilled water and dried in an oven at 50° C. 100 ml of 1 M HCl (manufactured by Samchun Chemical Co., Ltd.) was added per 1 g of the dried sample and changed every day while being stirred for three days. Thereafter, 0.5 ml of 40 wt % TBAOH (Tetrabutylammonium hydroxide) (manufactured by Sigma Aldrich) and 125 ml of distilled water were added per 0.5 g of the sample washed with distilled water until neutral and dried and were stirred at room temperature for 10 days. The precipitate was filtered from the synthesized solution by using a centrifuge to synthesize stripped RuO₂ nanosheet.

(b) Manufacturing of Two-Dimensional Metal Phosphide Nanosheet

The RuO₂ nanosheet obtained in the step (a) was heat-treated with NaH₂PO₂·H₂O under 99.99% nitrogen gas atmosphere at the temperature of 400° C. for two hours to manufacture the ruthenium phosphide two-dimensional nanosheet which was named as (Ru₂P-400).

### Examples 2-2 and 2-3

Manufacturing was performed in the same manner as in Example 2-1, except that the heat treatment was performed with the heat treatment temperatures of the step (b) changed, and the resultants were named as Ru₂P-450 and Ru₂P-500, respectively.

### Comparative Example 2-1

As a comparative example, the ruthenium oxide nanosheet manufactured in the step (a) of Example 2-1, instead of the ruthenium phosphide nanosheet, was prepared and named as RuO₂NS.

### Experiment Example 2-1 Hydrogen Evolution Reaction (HER) Performance Measurement

2 mg of Examples 2-1 to 2-3 and Comparative Example 2-1 and Ru₂P in the bulk state, and 0.5 mg of conductive carbon (Vulcan-XC72R) were dissolved in a solution of 1 ml of deionized water and 0.25 ml of an isopropanol, 20 μl of a 5 wt % Nafion solution (manufactured by Sigma Aldrich) was introduced, and the resultant was dispersed by ultrasonication (JAC-3010 manufactured by Kodo Technical Research Co., Ltd.). 10 μl of the dispersed solution was sampled on a glassy carbon (GC) rotating disk electrode (RDE) (manufactured by ALS Co., Ltd.). An SCE electrode was used as a reference electrode, and Pt wire was used as a counter electrode. The measurement was performed by using a RRDE-3A rotating ring disk electrode apparatus (manufactured by ALS Co., Ltd.) to test the hydrogen evolution reaction catalytic activity in an electrolyte in which N₂ was purged for 30 minutes or more. The catalyst measurement was performed in two electrolytes of 1 M KOH and 0.5 M H₂SO₄ and is shown in FIG. 12.

With reference to FIGS. 12A and 12B, it can be understood that the ruthenium phosphide nanosheets having holes according to the present invention in both of the two types of electrolytes have lower overpotential and higher currents than bulk Ru₂P. As a result, it can be confirmed that the ruthenium phosphide nanosheets having holes according to the present invention has excellent electrochemical catalytic efficiency, and it can be understood that the electrochemical catalyst according to the present invention can replace the platinum catalyst since the ruthenium phosphide nanosheets according to the present invention exhibits a catalytic efficiency three times or more excellent than a platinum catalyst.

### Experiment Example 2-2 SEM Images

Scanning electron microscope images (Field Emission-Scanning Electron Microscopy by JSM-7001F manufactured by JEOL Ltd.) of Examples 2-1 to 2-3 and Comparative Example 2-1 were checked and are shown in FIG. 8.

### Experiment Example 2-3 TEM and AFM Images

A transmission electron microscope image (Transmission electron microscopy by JEM-F200 manufactured by JEOL Ltd.) and a scanning probe microscope image (atomic force microscope, NX-10 manufactured by Park Systems Corporation) of Example 2-2 were checked and are shown in FIG. 9.

With reference to FIGS. 8 and 9, it is confirmed that the ruthenium oxide nanosheet according to Comparative Example 2-1 did not have holes, but it can be understood that holes penetrating the surfaces of the ruthenium phosphide nanosheets are formed in the ruthenium oxide nanosheets obtained by performing the step (b) according to the examples by varying the temperatures. That is, it can be understood that the holes can be formed in the surface of the two-dimensional nanosheet according to the heat treatment condition of the step (b), and the specific surface area for performing the catalytic reaction can be increased by such holes, to greatly enhance the catalytic efficiency. Also, it is confirmed that the thickness of the synthesized ruthenium phosphide nanosheet is as thin as 0.8 nm or less.

Experiment Example 2-4 X-Ray Diffraction Pattern Analysis The X-ray diffraction patterns of Examples 2-1 to 2-3 were analyzed (X-ray diffraction MiniFlex600 manufactured by Rigaku Corporation) and are shown in FIG. 10.

With reference to FIG. 10, it can be understood that the two-dimensional nanosheets obtained by synthesizing ruthenium oxide as metal oxide nanosheet precursors according to the preferred embodiment of the present invention at the heat treatment temperatures of 400° C. to 450° C. were all synthesized to ruthenium phosphide (Ru₂P) without impurities.

### Experiment Example 2-5 XANES and EXAFS

X-ray absorption near edge structures (XANES) and extended X-ray absorption fine structures (EXAFS) of Examples 2-1 to 2-3 and Comparative Example 2-1 (Pohang Light Source (PLS)), Ru₂P in a bulk state, and pure ruthenium metal were measured, and the results thereof are shown In FIG. 11 and Table 1 below.

Also, with reference to FIGS. 10 and 11, when compared with the X-ray diffraction pattern of theoretical ruthenium phosphide, it can be confirmed that the ruthenium phosphide nanosheets manufactured according to the examples of the present invention have Ru₂P crystal phases without impurities, and it can also be confirmed that complete phase transitions were occurred in the ruthenium oxide nanosheets, which were the precursors, by the heat treatment. Since FT-EXAFS shape are similar when compared with the Ru₂P nanoparticles in a bulk state, it can be understood that pure ruthenium phosphide nanosheets are formed without forming other crystal phases.

Also, with reference to Table 1 below, phosphorus-lattice defects can be confirmed by the EXAFS fitting analysis, and such phosphorus-lattice defects serve as active sites capable of performing a catalytic reaction to further improve the catalytic efficiency.

TABLE 1

| | Bonding | Coordination | R | ΔE | σ² | R |
|---|---|---|---|---|---|---|
| Material | pair | number | (Å) | (eV) | (10⁻³ × Å²) | factor |
| Ru₂P-NP450 | (Ru—P) | 2.0 | 2.26 | 0.12 | 3.3 | 0.008 |
| | (Ru—P) | 2.0 | 2.39 | 0.12 | 3.3 | |
| | (Ru—Ru) | 3.0 | 2.75 | 0.72 | 5.4 | |
| | (Ru—Ru) | 5.0 | 2.84 | 0.72 | 5.4 | |
| Ru₂P-NS400 | (Ru—P) | 1.8 | 2.25 | −3.74 | 5.0 | 0.005 |
| | (Ru—P) | 1.8 | 2.38 | −3.74 | 5.0 | |
| | (Ru—Ru) | 2.4 | 2.75 | 0.51 | 6.9 | |
| | (Ru—Ru) | 3.9 | 2.84 | 0.51 | 6.9 | |
| Ru₂P-NS450 | (Ru—P) | 1.9 | 2.25 | −1.93 | 4.1 | 0.006 |
| | (Ru—P) | 1.9 | 2.38 | −1.93 | 4.1 | |
| | (Ru—Ru) | 2.7 | 2.75 | 1.55 | 5.7 | |
| | (Ru—Ru) | 4.5 | 2.84 | 1.55 | 5.7 | |
| Ru₂P-NS500 | (Ru—P) | 2.0 | 2.26 | −0.66 | 4.2 | 0.006 |
| | (Ru—P) | 2.0 | 2.38 | −0.66 | 4.2 | |
| | (Ru—Ru) | 2.9 | 2.75 | 0.94 | 5.3 | |
| | (Ru—Ru) | 4.9 | 2.84 | 0.94 | 5.3 | |

According to the present invention, a specific surface area capable of performing a reaction can be significantly improved by implementing an electrochemical catalyst including metal catalyst materials and metal phosphide catalyst materials into a two-dimensional metal nanosheet so as to fully use the metal catalyst materials and the metal phosphide catalyst materials with excellent electrical conductivity and, simultaneously, additionally forming holes or active sites in a surface of the nanosheet, and the utilization of the catalyst can be maximized since the manufacturing process is simple to facilitate mass synthesis and to be capable of implementing an ultra-thin film and a large area.

The effect of the present invention is not limited to the above effects and should be understood to include all effects that can be inferred from the configuration of the invention described in the detailed description or claims of the present invention.

1. A method of manufacturing an electrochemical catalyst comprising:
(1) a step of preparing a metal oxide nanosheet precursor; and
(2) a step of heat-treating the metal oxide nanosheet precursor in a hydrogen and argon gas atmosphere to manufacture a two-dimensional metal nanosheet.

2. The method of manufacturing the electrochemical catalyst according to claim 1,
wherein the step (2) includes forming holes in a surface of the two-dimensional metal nanosheet.

3. The method of manufacturing the electrochemical catalyst according to claim 1,
wherein the metal oxide nanosheet precursor in the step (1) is derived from metal selected from the group consisting of Re, V, Os, Ru, Ta, Jr, Nb, W, Ga, Mo, In, Cr, Rh, Mn, Co, Fe, Au, Cu, and Ag, or an alloy thereof or is derived from metal oxide including ruthenium oxide, vanadium oxide, manganese oxide, cobalt oxide, or a combination thereof.

4. The method of manufacturing the electrochemical catalyst according to claim 1,
wherein the step (2) includes performing heat treatment at 100° C. to 700° C.

5. The method of manufacturing the electrochemical catalyst according to claim 1,
wherein the step (2) includes performing heat treatment in a hydrogen and argon gas atmosphere of 1% to 99%.

6. An electrochemical catalyst comprising:
a surface having holes therein; and
at least one two-dimensional metal nanosheet.

7. The electrochemical catalyst according to claim 6,
wherein each of the at least one two-dimensional metal nanosheet is derived from metal selected from the group consisting of Re, V, Os, Ru, Ta, Jr, Nb, W, Ga, Mo, In, Cr, Rh, Mn, Co, Fe, Au, Cu, and Ag or any one or more selected from the group consisting of alloys thereof or is derived from any one or more selected from the group consisting of metal oxide including ruthenium oxide, vanadium oxide, manganese oxide, cobalt oxide, or a combination thereof.

8. The electrochemical catalyst according to claim 6,
wherein a thickness of each of the at least one two-dimensional metal nanosheet is to 10 nm.

9. The electrochemical catalyst according to claim 6,
wherein a size of each of the at least one two-dimensional metal nanosheet is 1 to nm.

10. The electrochemical catalyst according to claim 6,
wherein the electrochemical catalyst is used as a catalyst in hydrogen evolution reaction (HER).

11. A method of manufacturing an electrochemical catalyst comprising:
(a) a step of preparing a metal oxide nanosheet precursor; and
(b) a step of subjecting the metal oxide nanosheet precursor to phosphorization reaction to manufacture a two-dimensional metal phosphide nanosheet.

12. The method of manufacturing the electrochemical catalyst according to claim 11,
wherein the step (b) includes forming holes penetrating the two-dimensional metal phosphide nanosheet.

13. The method of manufacturing the electrochemical catalyst according to claim 11,
wherein in the step (b), heat treatment is performed in a nitrogen gas atmosphere at 300° C. to 600° C.

14. The method of manufacturing the electrochemical catalyst according to claim 11,
wherein the step (b) includes forming a phosphorus (P)-lattice defect.

15. The method of manufacturing the electrochemical catalyst according to claim 11,
wherein the metal oxide nanosheet precursor in the step (a) is derived from metal selected from the group consisting of Re, V, Os, Ru, Ta, Jr, Nb, W, Ga, Mo, In, Cr, Rh, Mn, Co, and Fe, or an alloy thereof.

16. The method of manufacturing the electrochemical catalyst according to claim 11,
wherein the metal oxide nanosheet precursor has a layered structure stacked by hydrogen ions.

17. An electrochemical catalyst that includes nanomaterials, comprising:
a two-dimensional metal phosphide nanosheet having a phosphorus (P)-lattice defect.

18. The electrochemical catalyst according to claim 17,
wherein holes penetrating the two-dimensional metal phosphide nanosheet are formed.

19. The electrochemical catalyst according to claim 17,
wherein a thickness of the two-dimensional metal phosphide nanosheet is 0.01 to 1 nm.

20. The electrochemical catalyst according to claim 17,
wherein a size of the two-dimensional metal phosphide nanosheet is 1 to 10,000 nm.
